(19) United States
(12) Patent Application Publication
(10) Pub. No.: US 2008/0217011 A1
(43) Pub. Date: Sep. 11, 2008

(54) Methods for treating a subterranean formation with a treatment fluid containing a gelling agent and subsequently breaking the gel with an oxidizer

(75) Inventors: Richard W. Pauls, Duncan, OK (US); Michael W. Sanders, Duncan, OK (US)

Correspondence Address: ROBERT A. KENT, P.O. BOX 1431, DUNCAN, OK, 73536, US

(73) Assignee: Halliburton energy services, Inc.

(21) Appl. No.: 11/714,319

(22) Filed: Mar. 6, 2007

(51) Int. Cl. E21B 33/13; C09K 8/00

(52) U.S. Cl. 166/294

(57) ABSTRACT

A method is provided for treating a zone of a subterranean formation penetrated by a wellbore. The method includes a step of introducing a treatment fluid into a zone of a subterranean formation through the wellbore, wherein the treatment fluid comprises: (i) water; (ii) a gelling agent comprising a polymer grafted with a vinyl phosphonic acid or derivative thereof; and (iii) a crosslinking agent, and the step of subsequently introducing an oxidizer into a zone of a subterranean formation through the wellbore. According to another aspect the method includes a step of introducing a treatment fluid into a zone of a subterranean formation through the wellbore, wherein the treatment fluid comprises: (i) water; (ii) a gelling agent comprising a polymer grafted with a vinyl phosphonic acid or derivative thereof; and (iii) a magnesium oxide; and the step of: introducing an acid into the zone through the wellbore.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### FIELD OF THE INVENTION

This invention generally relates to recovering hydrocarbons from subterranean formations. More specifically, the invention relates to methods for treating a subterranean formation with a fluid containing a gelling agent.

### BACKGROUND OF THE INVENTION

Hydrocarbons (e.g., oil and natural gas) in a hydrocarbon-bearing zone of a subterranean formation can be reached by drilling a well into the subterranean formation.

After drilling an openhole, the next step is referred to as “completing” the wellbore. A wellbore is sometimes completed openhole, that is, without cemented casing in place over the producing formations. More typically, however, as part of the well completion process, a metal pipe, known as “casing” is positioned and cemented into place in the openhole.

The main purpose of cementing the casing is to stabilize the wellbore against collapse and to prevent undesirable migration of fluids along the wellbore between various zones of subterranean formations penetrated by the wellbore. Where the wellbore penetrates into a hydrocarbon-bearing zone of a subterranean formation, the casing can be perforated to allow fluid communication between the zone and the wellbore. A zone of a wellbore that penetrates a hydrocarbon-bearing zone that is capable of producing hydrocarbon is referred to as a “production zone.” The casing also enables subsequent or remedial separation or isolation of one or more production zones of the wellbore, for example, by using downhole tools such as packers or plugs, or by using other techniques, such as forming sand plugs.

Whether the wellbore is openhole or cased, various procedures are often employed to complete the wellbore in preparation for production of hydrocarbon. For example, one common procedure is gravel packing to help prevent sand and fines from flowing with the hydrocarbon produced into the wellbore, which particulate material can be damaging to pumps and other oilfield equipment and operations. Another example of a common procedure to stimulate the flow of hydrocarbon production from the hydrocarbon-bearing zones is hydraulic fracturing of a formation, which procedure is often referred to as “fracturing,” to provide an improved flow path for hydrocarbons to flow from the hydrocarbon-bearing formation to the wellbore. It is also common, for example, to gravel pack after a fracturing procedure, and such a combined procedure is sometimes referred to as a “FracPac^{SM}”, which is a service mark of Halliburton Energy Services, Inc., of Duncan, Okla.

After a well has been completed and placed into production, from time to time it is helpful to workover a well by performing major maintenance or remedial treatments. Workover includes the stimulation or remediation of a well to help restore, prolong, or enhance the production of hydrocarbons. During well servicing or workover, various treatment procedures may be used, including for example, gravel packing, hydraulic fracturing, and frac-packing as mentioned for well completion.

All of these procedures, from drilling the wellbore, to completion, to workover, employ appropriate fluids. During the initial drilling and construction of the wellbore, the fluids are often referred to as drilling fluids. In other stages, such as well completion, servicing, or workover, the fluids introduced into the wellbore are often referred to as completion fluids or as treatment fluids. A well treatment fluid is used for a wide range of purposes, such as stimulation, isolation, or control of reservoir gas or water. As used herein, however, a “treatment fluid” includes any appropriate fluid to be introduced into a wellbore, whether during drilling, completion, servicing, workover, or any other such stage.

Whether the wellbore is openhole or cased, it is often desirable to temporarily seal the formation face along one openhole or perforated zone of the wellbore to prevent loss of a well treatment fluid from the wellbore into a surrounding subterranean formation while treating a different openhole or perforated zone of the wellbore. A fluid loss treatment can be conducted on an openhole (non-cased) section of wellbore or a cased section of wellbore.

In some applications, for example, a treatment fluid for fluid loss control is used to deposit a filter cake in a zone of the wellbore. The filter cake can be deposited on the wall of the wellbore and/or on the face of the adjacent subterranean formation. The filter cake creates a pressure-tight seal that prevents fluid in the wellbore from being lost to the formation.

A treatment fluid for forming a filter cake can include water and can include, for example, water-soluble polymers such as hydroxyethylcellulose (HEC), other cellulose derivatives, or starch. The fluid can also include crosslinking agents to crosslink such polymers and further viscosify the treatment fluid. The treatment fluid can also contain appropriately-sized particles for bridging over the formation pores, thereby blocking fluid flow, or in the case of a fractured well, the pore throats of the proppant bed in the created fracture

Before placing a hydrocarbon-bearing zone into production, any filter cake in the production zone should be completely removed (if possible). One way the filter cake can be removed is by including acid-sensitive materials in the treatment fluid for building a filter cake. For example, the crosslinking agent may be selected for being sensitive to acid. By way of further example, acid-soluble bridging particles may be included in the treatment fluid for building the filter cake. When the deposited filter cake including such acid-sensitive materials is subsequently contacted with a sufficiently strong acidic solution for a sufficient time, the acidic solution breaks the cross-linked polymeric material or the polymer and/or dissolves the bridging particles, thereby destroying the filter cake.

There are problems with this technique for removing a filter cake, however. For example, a strongly acidic solution used in the process can sometimes corrode metallic surfaces and completion equipment such as sand screens and cause early failure. Furthermore, some types of subterranean formations can be damaged by the acidic solution, which may inhibit the production of hydrocarbon from the formation. For example, the use of acid as a breaker for the crosslinking agent can cause disintegration and dissolution of carbonate minerals. Contacting certain clay minerals such as zeolites and chlorite in the subterranean formation can result in gelatinous precipitation which can plug the pore spaces of the formation. Also, an acid wash can cause sludging of crude oil. Strong acids can also create a hot spot where it is possible that a relatively large percentage of the treating fluid can be lost to the formation, leaving a portion of the filter cake intact.

Efforts have been made to minimize the potential damage of using acid to remove a filter cake, however, these efforts are not always completely effective. For example, weighting of the acidic solution to keep it from being displaced by other fluids in the wellbore while contacting the filter cake can result in separation of the certain other components in the acidic solution, such as corrosion inhibitor, non-emulsifier, anti-sludging agents, etc.

According to another effort to avoid or minimize the use of acid to remove a filter cake, solid sodium chloride has been tried as the bridging agent in a treatment fluid for building a filter cake that is completely saturated with sodium chloride. As the treatment fluid is already saturated with the sodium chloride salt, the solid sodium chloride does not dissolve in the treatment fluid for building the filter cake. Subsequently, when it is desired to remove the filter cake deposited by such a treatment fluid, the filter cake can be contacted with relatively fresh water, which allows the solid sodium chloride used as the bridging agent in the filter cake to be dissolved. However, such under-saturated aqueous solutions require a relatively long period of time to dissolve the particles, primarily due to the polymeric viscosifying agents used in many well treatment fluids. That is, the polymeric materials in the filter cake and/or in the aqueous fluid that is undersaturated with sodium chloride tends to shield the water soluble bridging particles from the aqueous solution, greatly increasing the time required to remove the filter cake or even preventing the complete removal of the filter cake by this technique.

According to yet another effort to remove a filter cake, a delayed internal breaker for the polymer, i.e., a metal peroxide, has been used in treatment fluids used to build a filter cake. The internal delayed breaking of the polymer helps expose a solid, water-soluble bridging agent in the filter cake to an under saturated aqueous solution and allows the salt based particulate material to be dissolved. During the filter cake removal process, a mineral acid solution is placed in contact with the filter cake which activates the internal bridging agent of metal peroxide, thereby causing the polymeric materials in the filter cake to be decomposed. Thereafter, the filter cake is contacted with an under saturated aqueous solution to dissolve the filter cake. Generally, the time required for the metal peroxide and mineral acid solution to break up polymers and for the under saturated aqueous solution to dissolve the bridging agent has been relatively long making the process expensive and subjecting metal tools and parts in contact with the mineral acid solution to acid corrosion.

Other internal breakers have also been used to remove the polymeric materials in the filter cake. Internal breakers may, however, reduce the stability of the filter cake, which can allow a partially-broken pill to leak off into the surrounding formation, where it is much more difficult to remove.

Thus, there are long-felt and continuing needs for improved methods for treating a subterranean formation with a treatment fluid containing a gelling agent.

### SUMMARY OF THE INVENTION

The invention provides a method for treating a zone of a subterranean formation penetrated by a wellbore. The method comprises a step of introducing a treatment fluid into the zone of the subterranean formation through the wellbore, wherein the treatment fluid comprises: (i) water; (ii) a gelling agent comprising a polymer grafted with a vinyl phosphonic acid or derivative thereof; and (iii) a crosslinking agent. This method also includes a step of subsequently introducing an oxidizer into the zone through the wellbore.

The invention provides a method for treating a subterranean formation penetrated by a wellbore, the method comprising the steps of: (a) forming a gelled composition comprising: (i) water; (ii) a gelling agent comprising a polymer grafted with a vinyl phosphonic acid or derivative thereof; and (iii) a crosslinking agent; (b) shearing the gelled composition such that the gel is caused to break into sheared gel particles having an average particle size in the range of from about 10 to about 80 mesh with at least 50 percent having an average particle size below about 20 mesh; (c) slurrying the sheared gel particles with an aqueous fluid to produce a treatment fluid comprising a suspension of the gel particles; (d) introducing the treatment fluid into the zone of the subterranean formation through the wellbore; and (e) introducing an oxidizer into the zone through the wellbore. The oxidizer can be internal to the treatment fluid or subsequently introduced into the zone. The oxidizer can be substantially inactive until contacted with acid. If the oxidizer is substantially inactive until contacted with acid, the method also includes the step of introducing an acid into the zone through the wellbore. The acid can be subsequently introduced into the zone or the acid can be a delayed release acid in the treatment fluid. The oxidizing wash should be pumped after the crosslinked gel has already been pumped and the formation sealed. An internal delayed-release acid-generating compound can be included as part of the sealing pill, with the pill then contacted by an oxidizing wash.

While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### BRIEF DESCRIPTION OF THE DRAWING

The accompanying drawing is incorporated into and forms a part of the specification to illustrate an example of the present inventions. The drawing together with the description serves to explain the invention. The drawing is only for illustrating a preferred and alternative example of how the inventions can be made and used and is not to be construed as limiting the inventions to the illustrated and described example. Advantages of the present inventions will be apparent from a consideration of the drawing in which:

FIG. 1 is a graph illustrating the success of an external oxidizer solution in successfully breaking down a filter cake formed using a treatment fluid comprising water, a gelling agent comprising a polymer grafted with a vinyl phosphonic acid or derivative thereof; and a crosslinking agent.

### DETAILED DESCRIPTION OF THE PREFERRED EMBODIMENTS

U.S. Pat. No. 5,304,620 issued on Jun. 16, 1993, having named inventors Marlin D. Holtmyer, Charles V. Hunt, Mary A. H. Laramay, and Alireza B. Rahimi, describes a method of treating a subterranean formation using a gel of a graft copolymer of a hydroxyalkyl cellulose, guar or hydroxypropyl guar prepared by a redox reaction with vinyl phosphonic acid. The gel is formed by hydrating the graft copolymer in an aqueous liquid containing at least a trace amount of at least one divalent cation. The gel is crosslinked by the addition of Lewis base or Bronsted-Lowry base, which is substantially free of polyvalent metal ions, to the gel in an amount sufficient to effect crosslinking of the graft copolymer. U.S. Pat. No. 5,304,620 is hereby incorporated by reference in its entirety.

U.S. Pat. No. 5,439,057 issued on Aug. 8, 1995, having named inventors Jimmy D. Weaver and Ronald E. Himes, describes a method of controlling fluid loss to a permeable formation penetrated by a wellbore. A novel fluid loss agent is prepared by forming a crosslinked polymer gel which then is sheared to break the gel into discrete particles. A slurry then is formed of the particles by dispersing the particles in an aqueous fluid having a density similar to that of the gel particles. The slurry then is introduced into contact with the permeable formation and a filter cake of the particles is formed upon contact with the formation and loss of the slurrying fluid to the formation. The filter cake provides further fluid loss control to the permeable formation. U.S. Pat. No. 5,439,057 is hereby incorporated by reference in its entirety.

U.S. Pat. No. 5,680,900 issued on Oct. 28, 1997, having named inventors Philip D. Nguyen, David L. Brown, Jimmy D. Weaver, Wes C. Lavin, and Steven F. Wilson, describes a method of controlling fluid loss to a permeable formation penetrated by a wellbore. A novel fluid loss agent is prepared by forming a crosslinked polymer gel which then is sheared to break the gel into discrete particles of a particular size range. Slurry then is formed of the particles by dispersing the particles in an aqueous fluid having a density similar to that of the gel particles. The slurry then is introduced into contact with the permeable formation and a filter cake of the particles is formed upon contact with the formation and loss of the slurry fluid to the formation. The filter cake provides further fluid loss control to the permeable formation. U.S. Pat. No. 5,680,900 is hereby incorporated by reference in its entirety.

U.S. Pat. No. 5,996,694 issued on Dec. 7, 1999, having named inventors Brahmadeo T. Dewprashad, and R. Clay Cole, which is hereby incorporated by reference in its entirety, discloses methods and compositions for preventing high density well completion fluid loss. The methods basically comprise the steps of preparing a high density cross-linked aqueous gelled composition having the rigidity required to resist entry into a permeable subterranean formation penetrated by a well bore, placing the high density cross-linked aqueous gelled composition in the portion of the well bore within the permeable subterranean formation and placing a high density completion fluid in the well bore behind the high density cross-linked gelled composition. U.S. Pat. No. 5,996,694 is hereby incorporated by reference in its entirety.

Previously, to break filter cake deposited by the treatment fluids described above, delayed internal breakers such as the ones described above were injected with the treatment fluids. Another way to break filter cake deposited by the treatment fluids described above is by use of acidic washes that are injected after the treatment fluid has been introduced into the subterranean formation. As mentioned above, the use of the delayed internal breaker, however, sometimes results in an incomplete break in the filter cake and damage to the subterranean formation's permeability. Also, the use of an acid wash to break the filter cake deposited by the treatment fluids of the above described patents can result in corrosion damage, disintegration and dissolution of minerals in the formation, and sludging of crude oil, as mentioned above.

As used herein and in the appended claims, the words “comprise,”“has,” and “include” and all grammatical variations thereof are each intended to have an open, non-limiting meaning that does not exclude additional steps or elements.

According to one aspect, the invention provides a method for treating a zone of a subterranean formation penetrated by a wellbore. The method comprises a step of introducing a treatment fluid into the zone of the subterranean formation through the wellbore, wherein the treatment fluid comprises: (i) water; (ii) a gelling agent comprising a polymer grafted with a vinyl phosphonic acid or derivative thereof; and (iii) a crosslinking agent. This method also includes a step of subsequently introducing an oxidizer into the zone through the wellbore. The oxidizer provides a breaker without causing damage to the wellbore or formation. The breaker is preferably introduced as a wash in an aqueous solution after the treatment fluid is introduced into the subterranean formation.

Water or an aqueous fluid can be used to hydrate the gelling agent. The term “aqueous fluid” is used hereafter to mean water or any liquid containing sufficient concentration of water to at least partially hydrate the gelling agent and result in an increase in the viscosity of the fluid. Aqueous fluids used in oilfield operations normally contain sodium chloride, potassium chloride, calcium chloride, sodium bromide, calcium bromide and other bromides, ammonium chloride, zinc chloride, zinc bromide, sodium formate, and cesium formate and the like to weight the fluid or inhibit the swelling of clays often found in subterranean formations. The pH of the aqueous liquid can be adjusted so as to not adversely affect the hydration of the gelling agent and should be compatible with the selected crosslinking agent.

The polymer can comprise a polysaccharide-based polymer. Preferably, the polymer is hydratable. Examples of hydratable polysaccharide-based polymers include guar, guar derivatives, and cellulose derivatives. Suitable guar derivatives include hydroxypropyl-guar and carboxymethylhydroxypropylguar. Suitable cellulose derivatives include cellulose ethers, esters, and the like. Of these, water-soluble cellulose ethers are preferred, including but not limited to carboxyalkylcellulose ethers such as carboxyethylcellulose and carboxymethylcellulose, mixed ethers such as carboxymethyl-hydroxyethylcellulose, hydroxyalkylcelluloses such as hydroxyethylcellulose and hydroxypropylcellulose, alkylhydroxyalkylcelluloses such as methylhydroxypropylcellulose, alkylcelluloses such as methylcellulose, ethylcellulose and propylcellulose, alkylcarboxyalkylcelluloses such as ethylcarboxymethylcellulose, alkylalkylcelluloses such as methylethylcellulose, hydroxyalkylalkylcelluloses such as hydroxypropylmethylcellulose, and the like.

According to a presently most preferred embodiment of the invention, a hydroxyalkyl cellulose is used. Preferably, hydroxyalkyl cellulose has a hydroxyalkyl molar substitution from about 1.5 to about 3. Molar substitution is defined herein as the average number of moles of a substituent group present per anhydroglucose unit of the cellulose material. The alkyl group is selected from the group of ethyl, propyl, and mixtures thereof. A preferred hydroxyalkyl cellulose is hydroxyethyl cellulose (“HEC”) having a molar substitution in the range of about 1.8 to about 2.5. Preferably in this invention, the hydroxyalkylation of the cellulose is preformed in a separate reaction. Hydroxyethyl cellulose is usually formed by reacting ethylene oxide with cellulose under extreme alkaline conditions and is available commercially.

The polymer can comprise a synthetic polymer such as an acrylamide, an acrylate, or a copolymer thereof. Thus, the present invention includes the use of both natural and synthetic polymers.

The gelling agent of the invention is formed by grafting certain vinyl monomers comprising a vinyl phosphonic acid or derivative thereof to the polymer. Vinyl phosphonic acid or derivative thereof (herein referred to as “VPA”) can include vinyl phosphonic acid monomers and polymers; salts of vinyl phosphonic acid monomers and polymers; mono esters of vinyl phosphonic acid monomers and polymers; and any mixtures thereof in any proportion. Preferably, the vinyl phosphonic acid or derivative comprises sodium or potassium vinyl phosphate. In general, the VPA can comprise any compound that is capable of releasing a phosphonate ion upon dissolution thereof in an aqueous fluid. Without being limited by any particular theory, it is believed that the monomers have the reactive CH₂ ═C— moiety that is believed to enable the monomer to attach to the polymer, rendering the gelling agent crosslinkable. Some suitable methods of grafting the cellulose derivative with VPA is disclosed in U.S. Pat. Nos. 5,304,620; 5,439,057; 5,680,900, all of which have been previously incorporated herein by reference above.

In one embodiment of the invention, the gelling agent is prepared by reacting the polymer with PVA using a redox system comprising, for example, the reaction product of hydrogen peroxide with a ferrous salt. The generalized redox reaction is believed to be represented by the formula:

H₂O₂+Fe⁺²→HO.+HO⁻+Fe⁺³ (Eq. 1)

The generalized initiation reaction is believed to be represented by the general formula:

RCH₂OH+HO.→H₂O+RCH₂O. (Eq. 2)

An advantage of this initiator is that radical production occurs at a reasonable rate over a wide temperature range whereby reactions can be carried out at room temperature, if desired. The free radical produced on the polymer initiates polymerization with the vinyl group of the monomer to produce the grafted polymer or gelling agent.

Typically, the polymer grafting is carried out in aqueous media wherein the polymer is partially dissolved or dispersed. The grafted polymer is prepared in acetone/water mixtures containing from about 55 to about 90% acetone. Reactions were carried out in a 1 liter kettle with a stirrer or a 1 liter jar at a temperature of from about 20° C. to about 60° C. The ratio of cellulose derivative to aqueous medium can range from about 1 gram per 100 ml to about 1 gram per 2 ml. The preferred ratio is from about 1 gram per 2 to 5 ml. The ratio of polymer to VPA monomer ranges from about 5 to about 40 grams per 1 gram of monomer. The preferred ratio is from about 6 to about 16. It is to be understood that the ranges set forth above are merely exemplary and that other temperatures, concentrations and the like maybe used to prepare the reaction product.

The polymerization reaction of this embodiment of the invention is chemically initiated by a redox system comprising the reaction product of hydrogen peroxide with a ferrous salt. Ferrous ions may be provided, for example, by salts such as ferrous ammonium sulfate, ferrous chloride, ferrous sulfate, ferrous acetate, ferrous oxalate, ferrous acetylacetonate and the like. A preferred source of ferrous ions is ferrous ammonium sulfate. Alternatively, other commonly used metal ion reductants may be used in place of the ferrous ions to generate the free radicals necessary to effect grafting and other forms of hydrogen peroxide such as t-butylhydroperoxide may be used.

Reaction times vary from about 15 minutes to about 4 hours depending upon the reaction conditions or the particular grafting monomer. Grafting reaction efficiency (% of monomer grafted) is generally less than about 75%. After the reaction is complete, the polymerization product is washed with acetone, filtered and dried.

In a preferred method of effecting the polymer grafting to form the gelling agent, the grafted polymer product is contained in a substantially storage stable slurry form. Typically, the media comprises a polyglycol, such as polypropylene glycol having molecular weights up to about 1000 such as “PPG-250” to “PPG-1000” polyglycol from Texaco Chemical Co., various polyethylene glycols and homopolymers of 1,2 butylene oxide having a molecular weight of from about 200 to about 400 which is present in an amount of from about 70 to about 95 percent by weight of the media and the remainder generally comprises water. The media also can comprise tetramethylammonium chloride in a similar amount or in admixture with a polyglycol. In a preferred embodiment the polyglycol comprises from about 86 to 92 percent by weight of the media. Reactions were carried out in a 5 liter kettle with a stirrer at a temperature of from about 20 to 60° C. The ratio of polymer to media ranges from about 1 gram per 100 ml to about 1 gram per 2 ml. The preferred ratio is from about 1 gram per 2 to 5 ml. The reaction media also may include a quantity of a dispersant or thixotrope such as alkyl quaternary ammonium montmorillonite (“CLAYTONE AF” thixotrope from E. C. C. America, Inc.) or dimethyldicocoammonium chloride to facilitate dispersion of the polymer in the media and improve suspension properties. The grafting reaction is performed as previously described using an appropriate redox system such as, for example, the ferrous salt with a source of peroxide. Since the metal ions are not removed from the product by washing as when a dry product is formed, a sequestrant for the metal ions may be added to the slurry at the conclusion of the reaction. The polymerization product has been found to remain readily dispersible or suspended in the slurry form over a period of time to facilitate storage and handling.

The grafted polymers hydrate in aqueous fluids and substantially increase the viscosity of aqueous fluids.

The viscosity of the treatment fluid is further increased with the addition of a crosslinking agent. Various crosslinking agents can be used to crosslink with the gelling agent. Preferred crosslinking agents in accordance with this invention comprise Bronsted-Lowry or Lewis bases. Examples of crosslinking agents include, but are not limited to, borate releasing compounds and compounds capable of releasing metal cations having a valence state of two or greater. Some metal cations are capable of having more than one valence state. Examples of suitable metal cations include, but are not limited to, magnesium, aluminum, titanium, zirconium, chromium, and antimony, and any mixture thereof in any proportion. Examples of crosslinking agents include a borate releasing compound such as sodium tetraborate and transition metal ion releasing compounds such as titanium dioxide, zirconium oxychloride, and chelates of aluminum, zirconium, or titanium.

According to particularly advantageous embodiments of the invention, a magnesium oxide, such as magnesium peroxide, is used as the crosslinker. An excess of magnesium oxide can be admixed with the gelled fluid during the crosslinking process resulting in the formation of a gel including intimately admixed solid magnesium oxide particles that will provide further assistance to the crosslinked gel particles in providing fluid loss control. Other fine particulate materials can be admixed with the polymer gel particles to assist in achieving desired fluid loss control.

A preferred crosslinking agent comprises magnesium oxide.

The concentrations of gelling agent and crosslinking agent that are used to form the treatment fluid can be an amount that is sufficient to achieve a desired viscosity level for the particular application. In the case of forming a filter cake for fluid loss control, the concentrations will depend, to some extent, upon the permeability of the formation, the formation temperature, and the desired degree of fluid loss control. An important factor is the fluid-loss differential pressure that is desired to be controlled. The gelled composition should have a sufficient stiffness or rigidity to resist fluid entry into a permeable subterranean formation when a fluid is under an expected contact pressure with a face of the subterranean formation.

Generally, the gelling agent is included in an amount in the range of from about 0.5% to about 2% by weight of the treatment fluid. Generally, the crosslinking agent is included in an amount in the range of from about 0.05% to about 0.5% by weight of the treatment fluid.

In one embodiment, the treatment fluid is formed of aqueous gelled compositions containing high concentrations of density increasing salts. Some density increasing salts include one or more of sodium chloride, sodium bromide, sodium acetate, sodium formate, sodium citrate, potassium chloride, cesium formate, potassium acetate, sodium nitrate, calcium chloride, calcium bromide, and zinc bromide. Common oilfield brines can also be used. The resulting composition develops a stable, high density, crosslinked aqueous gelled composition having a stiffness or rigidity sufficient to resist fluid loss into a permeable subterranean formation when in contact with a face of the subterranean formation.

As those skilled in the art understand, several methods can be used to prepare crosslinked aqueous gelled compositions. Light-weight versions are from about 8.3 to about 11.6 pounds per gallon (ppg). Medium-weight versions are from about 11.6 to about 14 ppg. Heavy-weight versions are greater than 14 ppg.

In general, for a light-weight version, a brine and gelling agent are added to a blender. An acid is added to reduce the pH, and time is allowed for the gel to hydrate. Then a crosslinking agent is added to slowly raise the pH such that the gel becomes crosslinked.

One method to prepare medium density crosslinked aqueous gelled compositions basically comprises the steps of combining from about 25 parts to about 100 parts by weight of the hydratable and crosslinkable gelling agent used with a relatively small quantity of water, e.g., from about 100 parts to about 200 parts by weight of the water to form a well dispersed slurry of the gelling agent in the water. For this particular purpose, the water used should preferably be fresh water or water containing a relatively small amount of dissolved salt or salts. To cause the uniform dispersion and hydration of the gelling agent, from about 1 to about 10% by weight of ethylene glycol or propylene glycol depending upon the brine being used as the base fluid is preferably included in the slurry. The slurry is added to a brine and the pH of the mixture is reduced with an acid to the pH in the range of from about 1 to about 6, and preferably below about 3. Thereafter, the density increasing, aqueous salt solution of the type described above having a density in the range of from about 8.3 to about 21.5 pounds per gallon is combined with the slurry to form an aqueous gelled salt solution. The amount of the aqueous salt solution added to the slurry is generally in the range of from about 60% to about 95% by weight of the resulting aqueous gelled salt solution and time is allowed for the gel to hydrate. Then a crosslinking agent is added to slowly raise the pH such that the gel becomes crosslinked.

Without being limited by theory and while the specific mechanism by which the crosslinking occurs is unknown, it is believed that the crosslinking is formed through the phosphorus moiety in the grafted polymer.

The treatment fluid can also include other conventional additives depending on the application of the treatment fluid. Examples of other conventional additives include, but are not limited to, proppants, solids suspending agents, pH adjusting and/or control agents, gel breakers, gel stabilizers, clay stabilizers, bactericides, fluid loss additives, surfactants, and weighting agents such as hematite, barite, and calcium carbonate, and the like. Such other conventional additives should not adversely react with or affect other components in the composition. The selection of such other additives is within the skill of the art.

In one aspect of the invention, the step of introducing the aqueous treatment fluid into the zone of the formation through the wellbore further comprises introducing the aqueous treatment fluid under conditions to produce a filter cake. Preferably, the step further comprises introducing the aqueous treatment fluid under conditions to produce an external filter cake on the face of the formation with minimal penetration of the filter cake into the formation.

Subsequent to the introduction of the treatment fluid into the zone of the subterranean formation, an oxidizer is introduced into the zone of the subterranean formation through the wellbore. The oxidizer is introduced into the wellbore and into contact with the treatment fluid or a filter cake deposited by the treatment fluid. The oxidizer should be in contact with a filter cake for a sufficient period of time such that the polymer and the filter cake formed by the gelling composition is substantially dissolved. Thereafter, the formation can be produced to remove any remaining material of the filter cake. It is contemplated that the external breaker of oxidizer wash may require an extended soak time compared to conventional 5% hydrogen chloride acid overflush.

The oxidizer can comprise of any oxidizer that is capable of breaking or dissolving the filter cake formed by the treatment fluid. Preferably, the oxidizer is selected from the group consisting of peroxide, organic peroxide, persulfate, hypochlorite, chlorite, and any mixture in any proportion thereof. According to a presently most preferred embodiment, the oxidizer comprises sodium persulfate.

The oxidizer can be in an aqueous fluid. The fluid with the oxidizer can be subsequently introduced as a wash into the wellbore. The aqueous fluid with the oxidizer can further include boric acid. The aqueous fluid with the oxidizer can further include hydrogen chloride. Thus, according to a presently most preferred embodiment of the invention, the wash for use in the invention is made up of water, an oxidizer, boric acid, and hydrochloric acid. In yet another example, a wash with the oxidizer further comprises any one or more of the following: formic acid, acetic acid, surfactants, clay stabilizer, and an anti-sludging agent.

The wash with the oxidizer can also be weighted through the addition of salt. Some preferred salts are selected from the group consisting of sodium chloride, potassium chloride, sodium bromide, calcium chloride, calcium bromide, zinc bromide, and any mixture thereof in any proportion. Other salts are also contemplated.

The wash with the oxidizer can also be made to be compatible with the formation crude oil by addition of a non-emulsifier. Further, through the addition of a buffering agent, the wash can be made to be compatible with the wellbore metallic components. Other additives can also be added to the oxidizer.

A wash solution of the oxidizer provides a rapid break of the filter cake formed by the treatment fluid previously introduced into the subterranean formation. The oxidizer does not damage the subterranean formation or metal components of the wellbore. Further, the oxidizer is more compatible to the formation crude oil. Preferably, the treatment fluid and the wash with oxidizer do not have any substantial concentrations of hydrochloric acid or dissolved iron to reduce the possibility that the treatment fluid or wash would cause crude oil sludging.

The invention also provides a method for treating a zone of a subterranean formation penetrated by a wellbore, the method comprising a step of introducing a treatment fluid into the zone of the subterranean formation through the wellbore, wherein the treatment fluid comprises: (i) water; (ii) a gelling agent comprising a polymer grafted with a vinyl phosphonic acid or derivative thereof; and (iii) a magnesium oxide.

Other internal breakers can be used in conjunction with the oxidizer clean-up compositions and methods according to the invention. Such internal breakers are included in U.S. Pat. No. 6,737,385, issued on May 18, 2004, by named inventors Bradley L. Todd, Raghava Reddy, James V. Fisk, Jr., and James D. Kercheville, and U.S. Pat. No. 6,494,263, issued on Dec. 17, 2002, by named inventor Bradley L. Todd, both of which are incorporated by reference in their entirety.

In another aspect, the invention provides a method for treating a subterranean formation penetrated by a wellbore, the method comprising the steps of: (a) forming a gelled composition comprising: (i) water; (ii) a gelling agent comprising a polymer grafted with a vinyl phosphonic acid or derivative thereof; and (iii) a crosslinking agent; (b) shearing the gelled composition such that the gel is caused to break into sheared gel particles having an average particle size in the range of from about 10 to about 80 mesh with at least 50 percent having an average particle size below about 20 mesh; (c) slurrying the sheared gel particles with an aqueous fluid to produce a treatment fluid comprising a suspension of the gel particles; (d) introducing the treatment fluid into the zone of the subterranean formation through the wellbore; and (e) introducing an oxidizer into the zone through the wellbore.

The step of slurrying the sheared gel particles with an aqueous fluid can comprise slurrying with brine solution. Further, the suspension of the gel particles can be mixed with sold particulate. Also, the step of introducing the aqueous treatment fluid into the formation through the wellbore further comprises introducing under conditions to produce a filter cake.

The invention can be used to control fluid loss after gravel pack, frac packing, as a chemical packer, to control sloughing, etc.

### EXAMPLE 1

This example illustrates be ability of an oxidizer to break a filter cake formed of gelling agent comprising a polymer grafted with a vinyl phosphonic acid or derivative thereof and a crosslinking agent.

A filter cake was formed of a treatment fluid having a gelling agent comprising a polymer grafted with a vinyl phosphonic acid or derivative thereof; and a crosslinking agent and having polylactic acid as an internal breaker mixed with 9.6 lbs per gallon NaBr/KCl brine. A Fann Model 90 Dynamic High Pressure, High Temperature (“HPHT”) test was conducted on the filter cake. The filter cake had already been in contact with polylactic acid internal breaker for a period of 18 days without evidence of substantial leakoff. Although the polylactic acid internal breaker appeared to have reversed the crosslinking of the filter cake as well as to have substantially reduced the viscosity of the filter cake, the filter cake was still intact and holding pressure. Thus, the internal breaker failed to completely break the filter cake.

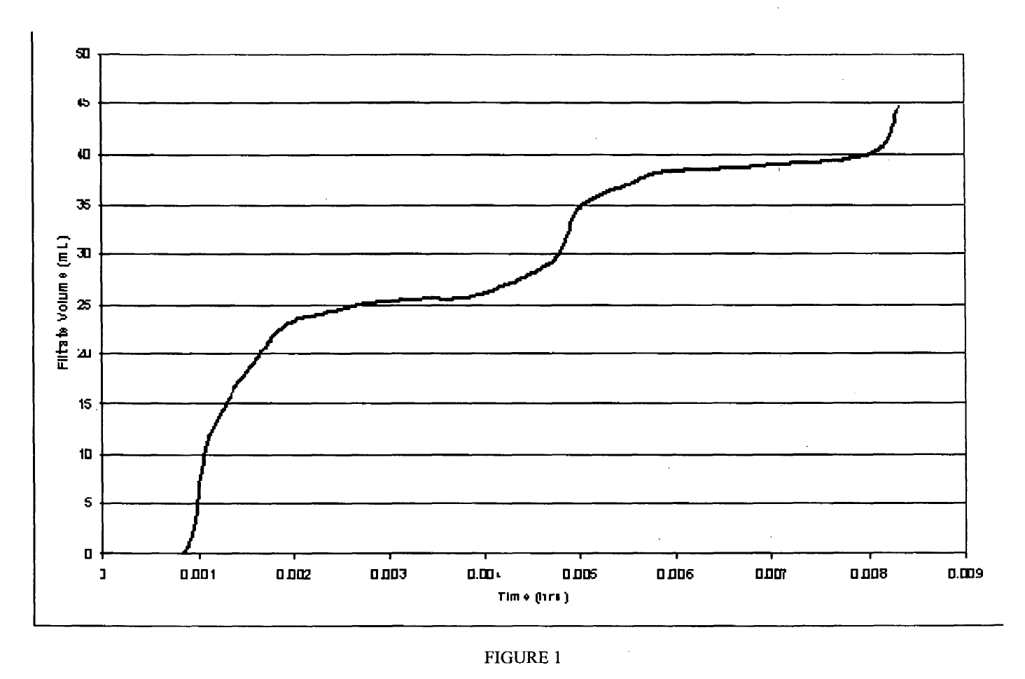

A solution of oxidizer was made by mixing 12 grams of sodium persulfate and 1.2 grams of sodium bicarbonate per 1,000 mL of tap water from Duncan, Okla. (“Duncan Tap Water” or “DTW”). The test was conducted by placing the solution of the oxidizer on top of the filter cake. The Fann Model 90 Dynamic HPHT test cell was started by placing the piston onto the solution of the oxidizer. The first part of the test consisted of heating up the system (without pressure). Then, pressure of 250 psi was applied to the system. Once pressure was applied to the system, the instrument had trouble keeping up with the filtrate volume, indicated by its cycling on and off over a short span of time. The fluid successfully and rapidly pumped through the filter cake and through the Aloxite (Fann) Disc. Thus, the oxidizer solution successfully broke down the filter cake while the test cell was heating up to the test temperature of about 178° F. (81° C.). FIG. 1 plots the filtrate volume in mL against time in hours (“hrs”) after the pumping test was started. Within about 0.008 hrs (about 0.5 minute), the pump cycled more than two times and the filtrate volume accumulated to about 45 mL. As shown by the graph of FIG. 1, the very rapid pumping of a large filtrate volume through the filter cake demonstrated that a very rapid break of the filter cake was achieved by the solution of oxidizer on the filter cake prior to the beginning of the pumping.

### EXAMPLE 2

The purpose of this test was to determine which of the components in a wash containing an oxidizer, i.e., a wash comprising water, boric acid, hydrochloric acid, and ammonium bifluoride (“ABF”), with an oxidizer of 100 lbs/MGal sodium persulfate or sodium perborate was causing the crosslinked gel to break.

This example was based on a well having a bottom hole temperature of 178° F. (81° C.) and a brine/density type of 9.6 ppg KCl/NaBr Brine.

In general, the crosslinked gel was aqueous containing a gelling agent comprising a polymer grafted with a vinyl phosphonic acid and 10 grams/Liter of magnesium peroxide, which is commercially available from TBC Brinadd, as a crosslinker and delayed in situ breaker. The grafted polymer was produced by the reaction of water soluble polymer such as hydroxyethyl celluslose (“HEC”) and a vinyl phosophonic acid in the presence of a redox system as disclosed in U.S. Pat. No. 5,304,620, which is incorporated herein by reference.

One liter of a water-soluble polymer at a loading of 120 lbs/Mgal was mixed with 951 mL of 9.6 ppg KCl/NaBr brine; 44 mL of phosphonated hydroxyethyl cellulose viscosifying agent commercially available from Halliburton Energy Services of Duncan, Okla.; and 5 mL of 20° Be HCl acid. The mixture was allowed it to hydrate for several hours. Ten grams/Liter of magnesium peroxide was mixed into the fluid as a crosslinker and delayed in situ breaker. The gel was allowed to crosslink for about 1 hour.

Several external breaker solutions were prepared to test their ability to break the crosslinked gel. The external breaker solutions are hereinafter described in Table 1.

Labels were made and attached to the lids for the bottles to be used in the test. 10 mL of the crosslinked gel was placed in each sample bottle. 50 mL of each external breaker solution above was placed into the respective bottles. The samples were placed in a 178° F. (81° C.) water bath for fifteen minutes. Samples were pulled out of the water bath and observed.

TABLE 1
Results of External Breaker Solution Tests

| | pH of | |
|---|---|---|
| | initial | |
| Description External Breaker Solution | solution | Comments |
| DTW | 0.74 | All of the crosslinked gel sample was |
| 1% hydrochloric acid (22° Be) | | dissolved after 15 minutes at 178° F. |
| 50 lb/MGal boric acid | | |
| (without ABF) | | |
| 100 lbs/MGal sodium persulfate | | |
| mixed with 9.6 ppg KCl/NaBr | | |
| DTW | 1.61 | All of the crosslinked gel sample was |
| 1% hydrochloric acid (22° Be) | | dissolved after 15 minutes at 178° F. |
| 50 lb/MGal boric acid | | |
| (without ABF) | | |
| 100 lbs/MGal sodium persulfate | | |
| DTW | 2.16 | The majority of the crosslinked gel |
| 1% hydrochloric acid (22° Be) | | sample was still visible after 15 minutes |
| 50 lb/MGal boric acid | | at 178°. |
| (without ABF) | | |
| 100 lbs/MGal sodium perborate | | |
| DTW | 2.0 | All of the crosslinked gel sample was |
| 1% hydrochloric acid (22° Be) | | dissolved after 15 minutes at 178° F. |
| 50 lb/MGal boric acid | | |
| 50 lb/MGal ABF | | |
| 100 lbs/MGal sodium persulfate | | |
| 9.6 ppg KCl/NaBr | | |
| DTW | 6.73 | Some the crosslinked gel sample |
| 50 lbs/MGal boric acid | | lumped after 15 minutes at 178° F. |
| 100 lbs/MGal sodium persulfate | | After about sitting on the counter top for |
| | | another 15 minutes, the gel seemed to |
| | | have dissolved. Some minor residue |
| | | appeared to be un-dissolved sodium |
| | | persulfate breaker. |

Based on the results of these tests, it appears that the ABF in a solution with the oxidizer is not a necessary component when using the oxidizer as an external overflush for the crosslinked gel sample pill at a temperature of 178° F. (81° C.). The combination of HCl and ABF makes HF acid, which has good dissolving power but is susceptible to precipitation problems.

Tests run using 100 lbs/MGal sodium persulfate and 50 lbs/MGal Boric acid mixed in tap water from Duncan, Okla. (“DTW”) also appeared to break the crosslinked gel sample pill albeit over a longer period of time (30 minutes rather than 15 minutes).

After careful consideration of the specific and exemplary embodiments of the invention described herein, a person of ordinary skill in the art will appreciate that certain modifications, substitutions and other changes can be made without substantially deviating from the principles of the invention. The detailed description is illustrative, the spirit and scope of the invention being limited only by the appended Claims.

1. A method for treating a zone of a subterranean formation penetrated by a wellbore, the method comprising the steps of:
a. introducing a treatment fluid into the zone of the subterranean formation through the wellbore, wherein the treatment fluid comprises:
i. water;
ii. a gelling agent comprising a polymer grafted with a vinyl phosphonic acid or derivative thereof, wherein the polymer is a hydratable polysaccharide-based polymer selected from the group of cellulose derivatives; and
iii. a crosslinking agent; and
b. subsequently introducing an oxidizer into the zone through the wellbore.

2-3. (canceled)

4. The method according to claim 1, wherein the hydratable polysaccharide-based polymer is hydroxyalkyl cellulose having a molar alkyl substitution of from about 1.5 to about 3, the alkyl being selected from the group of ethyl and propyl.

5. The method according to claim 1, wherein the vinyl phosphonic acid or derivative thereof is selected from the group consisting of:
a. vinyl phosphonic acid monomers and polymers;
b. salts of vinyl phosphonic acid monomers and polymers;
c. mono esters of vinyl phosphonic acid monomers and polymers; and
d. any mixtures thereof in any proportion.

6. The method according to claim 1, wherein the vinyl phosphonic acid or derivative thereof forms a vinyl phosphonate ion upon dissolution in an aqueous fluid.

7. The method according to claim 1, wherein the vinyl phosphonic acid or derivative thereof comprises sodium or potassium vinyl phosphate.

8. The method according to claim 1, wherein the gelling agent is in the range of from about 0.05% to about 2.0% by weight of the treatment fluid.

9. The method according to claim 1, wherein the crosslinking agent comprises Lewis base or Bronsted-Lowry base.

10. The method according to claim 1, wherein the crosslinking agent comprises a compound capable of releasing a metal cation having a valence state of two or greater.

11. The method according to claim 1, wherein the crosslinking agent is selected form the group of borates, magnesium, aluminum, titanium, zirconium, chromium, antimony, and any mixture thereof in any proportion.

12. The method according to claim 1, wherein the crosslinking agent comprises magnesium oxide.

13. The method according to claim 1, wherein the crosslinking agent is in the range of from about 0.05% to about 0.5% by weight of the aqueous treatment fluid.

14. The method according to claim 1, wherein the treatment fluid further comprises a solid particulate.

15. The method according to claim 1, wherein the treatment fluid further comprises polylactic acid.

16. The method according to claim 1, wherein the treatment fluid further comprises an orthoester.

17. The method according to claim 1, wherein the oxidizer is in an aqueous fluid and the oxidizer is selected from the group consisting of peroxide, organic peroxide, persulfate, hypochlorite, chlorite, and any mixture thereof in any proportion.

18. The method according to claim 17, wherein the aqueous fluid further comprises boric acid.

19. The method according to claim 17, wherein the aqueous fluid further comprises hydrochloric acid.

20. The method according to claim 19, wherein the oxidizer comprises sodium persulfate.

21. The method according to claim 17, wherein the aqueous fluid further comprises a salt selected from the group consisting of: sodium chloride, sodium bromide, sodium acetate, sodium formate, sodium citrate, potassium chloride, cesium formate, potassium acetate, sodium nitrate, calcium chloride, calcium bromide, and zinc bromide, and any mixture thereof in any proportion.

22. The method according to claim 1, wherein the step of introducing the treatment fluid into the formation through the wellbore further comprises introducing the treatment fluid under conditions to produce a filter cake.

23. The method according to claim 1, wherein the step of introducing the treatment fluid into the formation through the wellbore further comprises introducing the treatment fluid under conditions to produce an external filter cake on the formation face to the wellbore with minimal penetration of the filter cake into the formation.

24. A method for treating a zone of a subterranean formation penetrated by a wellbore, the method comprising the steps of:
a. forming a gelled composition comprising:
i. water;
ii. a gelling agent comprising a polymer grafted with a vinyl phosphonic acid or derivative thereof, wherein the polymer is a hydratable polysaccharide-based polymer selected from the group of cellulose derivatives; and
iii. a crosslinking agent;
b. shearing the gelled composition such that the gel is caused to break into sheared gel particles having an average particle size in the range of from about 10 to about 80 mesh with at least 50 percent having an average particle size below about 20 mesh;
c. slurrying the sheared gel particles with an aqueous fluid to produce a treatment fluid comprising a suspension of the gel particles;
d. introducing the treatment fluid into the zone of the subterranean formation through the wellbore; and
e. subsequently introducing an oxidizer into the zone through the wellbore.

25. The method according to claim 24, wherein the treatment fluid further comprises a solid sold particulate.

26. The method according to claim 24, wherein the treatment fluid further comprises polylactic acid.

27. The method according to claim 24, wherein the treatment fluid further comprises an orthoester.

28. The method according to claim 24, wherein the step of introducing the treatment fluid into the zone of the formation through the wellbore further comprises introducing the treatment fluid under conditions to produce a filter cake.

29. The method according to claim 24, wherein the step of introducing the treatment fluid into the formation through the wellbore further comprises introducing the treatment fluid under conditions to produce an external filter cake on the formation face to the wellbore with minimal penetration of the filter cake into the formation.
